(19) United States
(12) Patent Application Publication
(10) Pub. No.: US 2004/0023198 A1
(43) Pub. Date: Feb. 5, 2004

(54) System, method, and computer program for providing multi-media education and disclosure presentation

(76) Inventor: Darrell Youngman, Wichita, KS (US)

Correspondence Address: HOVEY WILLIAMS LLP, Suite 400, 2405 Grand, Kansas City, MI, 64108, US

(21) Appl. No.: 10/209,420

(22) Filed: Jul. 30, 2002

(51) Int. Cl. G09B 23/28

(52) U.S. Cl. 434/262; 434/307 R; 434/365

(57) ABSTRACT

A system, method, and computer program for providing a multi-media education and disclosure presentation on a medical or other health-related subject to a patient or other interested persons. The system may be fixed or portable in nature and broadly includes a touchscreen for communicating the presentation and facilitating input; a plurality of wheels to enhance portability; a printer to print a consent form following the presentation; and an adjustable boom for positioning the touchscreen for comfortable viewing by the patient. The presentation broadly comprises a background section; a condition section; a remedy section; and a lifestyle section, and each such section is represented by one or more detailed topic pages. The presentation incorporates a variety of media elements, such as video, audio, still images, and text, and images or sound taken from diagnostic medical equipment.

### BACKGROUND OF THE INVENTION

1. Field of the Invention

The present invention relates broadly to mechanisms for providing presentations on health-related subjects. More particularly, the present invention concerns a system, method, and computer program for providing a multi-media education and disclosure presentation on a medical or other health-related subject to a patient or other interested persons, wherein, in one embodiment, the system is portable, adjustable, and otherwise adapted to facilitate use by the patient and includes a printer to print a consent form, and wherein the presentation includes a background section, a condition section, a remedy section, and a lifestyle section, and incorporates a variety of media elements, such as, for example, video, audio, still images, and text.

2. Description of the Prior Art

In a health-care provider setting it is often necessary and desirable to provide an educational presentation on a medical or other health-related subject. In a hospital, for example, it is often necessary and desirable to provide such a presentation to both patients and other interested persons (e.g., family members, friends) on a medical condition associated with the patient, thereby providing them with the knowledge they need to understand the causes, remedies, and lifestyle changes related to the condition. Such a presentation may also be necessary or desirable to facilitate and obtain informed consent.

Traditionally, a health-care professional, either a physician or a nurse specializing in public education, discusses these issues with the patient and their family. These discussions are typically oral, though they may be supplemented with pamphlets, brochures, or other printed material, often provided by third-party product suppliers. It will be appreciated that, unfortunately, these discussions suffer from a variety of problems and disadvantages, including the substantial time required to present the information to the patient and the family. Often, the physician or nurse cannot schedule the discussion for some time following the patient's admission, thereby potentially leaving both the patient and their family without even the most rudimentary understanding of the patient's condition. This can lead to substantial anxiety and other undesirable mental stress. Furthermore, circumstances may dictate that the physician or nurse have the discussion multiple times, particularly where one or more family members arrive substantially later than the patient or other family members. This can result in inefficient and otherwise undesirable redundancy.

Additionally, because presenting the information and answering any questions can take a substantial period of time, it is not uncommon for the physician or nurse to be interrupted and have to discontinue the discussion. Returning later to the same point in the discussion can be difficult or impossible, and the physician or nurse may have to begin the discussion again, particularly if a substantial period of time has passed during the interruption in which the patient or their family has forgotten details of the information. This can result in further inefficiency and otherwise undesirable redundancy.

Additionally, the patient or their family may not understand the physician's presentation, particularly if the physician is rushed, and may have no opportunity to review the information on their own or to ask questions at a later time. This is particularly a problem where the patient or a family member are emotionally distraught due to the patient's condition or are otherwise unable to absorb and understand all of the information being presented. This lack of understanding can undesirably undermine obtaining informed consent.

Additionally, the physician's presentation, being from memory and not standardized, may change slightly or dramatically with each telling, such as, for example, where the physician forgets an issue or risk that should be discussed. This may leave the patient or their family with an inaccurate understanding of the condition and associated risks and a greater or lesser than realistic apprehension. This omission can undesirably undermine obtaining informed consent.

As mentioned, it is known for the physician or nurse to supplement their oral discussion with a printed pamphlet or brochure or with a video cassette presentation. Unfortunately, pamphlets and brochures are substantially limited with regard to both the amount of information they are able to contain and convey and the media elements used in the presentation, typically being limited to a few still images and a relatively short and less than satisfying text. Similarly, video cassette presentations are also limited with regard to interactivity and ability to navigate the presentation.

It is also known for family members to pursue their own research of the patient's condition using, for example, various library or network-accessible resources. A family member might, for example, access information via the Internet using a laptop computer. Unfortunately, such research typically cannot be performed from a hospital waiting room or patient's suite. Commonly, these locations do not provide network connections and do not allow wireless connections or, in some cases, even the operation of a personal computer because of potential electromagnetic interference with vital hospital equipment.

Due to the aforementioned problems and disadvantages in the prior art, a need exists for an improved mechanism for providing presentations to patients and their family members on medical or other health-related subjects.

### SUMMARY OF THE INVENTION

The present invention overcomes the above-identified and other problems and disadvantages in the prior art with a system, method, and computer program for providing a multi-media education and disclosure presentation on a medical or other health-related subject to a patient or other interested persons, such as, for example, family members or friends.

In a preferred first embodiment, the system is adapted for substantially fixed use in, for example, a foyer, waiting room, or similar environment for convenient access by the patient's family and friends. As such, the system broadly comprises a housing; a processor; CD-ROM/DVD player or a network port; a touchscreen and a keyboard; a speaker and a headphone jack; a volume control knob; and a power plug The housing protectively houses and encloses other components of the system, and includes an exterior; an interior; and a cover. The exterior of the housing is shaped to present generally flat or gently rounded surfaces, thereby facilitating more efficient cleaning. The interior provides a cavity wherein other components of the system are protectively located. The interior is accessed through an opening in a rear portion of the housing. The cover is adapted to be removably positioned and secured over the opening so as to substantially seal the interior and further protect the components located therein while allowing authorized access thereto. To ensure against unauthorized access, a locking mechanism is incorporated into the cover.

The processor is adapted to access and control and communicate the presentation, and to receive input from the user. The CD-ROM/DVD player is adapted to receive a memory device or medium on which the presentation is stored, to retrieve the information, and to provide the retrieved information to the processor. Alternatively or additionally, the system may include the network port adapted to allow for connecting the processor to a local or wide area network so that the presentation can be accessed from a remote host.

The touchscreen is adapted to both visually communicate a visual component of the presentation and to allow the user to provide input for navigating and otherwise controlling the presentation. In a conventional manner, movement of an object, such as, for example, a finger, stylus, or other pointing device, on the touch-sensitive surface of the touchscreen results in an input being provided to the processor. In this manner, the user can touch a virtual control that is part of the presentation to provide control input. Thus, the touchscreen provides a self-contained and intuitive mechanism for controlling the presentation. The keyboard is adapted to also allow for providing input to the processor, and is stored within the interior of the housing and accessed via the opening when needed.

The speaker is adapted to audibly communicate an audible component of the presentation. The headphone jack provides an alternative to the speaker. Inclusion of the headphone jack is particularly advantageous as, in hospitals and other health-care environments where noise is frequently undesirable, it allows for using the system without disturbing others. The volume control knob is actuatable by the user to control the volume of the presentation through the speaker or the headphone jack. The power plug provides a connection point for connecting an external power source to the system to provide power thereto.

A preferred second embodiment of the system is adapted for portable use by the patient in the patient's room or suite or similar environment. As such, the system broadly further includes a plurality of wheels; an adjustable boom; a printer; and a battery. The plurality of wheels are mounted to a bottom portion of the housing and are adapted to support the remainder of the system and to allow for wheeled movement thereof, thereby further enhancing the portable nature of the system.

The adjustable boom is an elongated substantially cylindrical support structure adapted to locate and support the touchscreen in a desired position. The boom includes a first end having a first ball joint coupled with the housing; a second end having a second ball joint coupled with the touchscreen; and two or more telescopically, hingedly, or otherwise adjustable sections extending therebetween. Thus, the boom is adjustable in three dimensions to facilitate positioning the touchscreen for optimum viewing. This feature is particularly advantageous where the patient is confined to a bed, in which case the wheeled housing can remain next to the bed while the touchscreen is positioned nearer the patient.

The printer allows for printing a consent form when the patient has completed the presentation. As desired, the printer can provide other verification and documentation (e.g., a usage report with date/time stamp) of the patient's having used the system and thereby received the presentation.

The battery supplements the power plug in providing power to the components of the system. Inclusion of the battery further enhances the portable nature of the system by allowing the system to continue to receive power and remain on and avoid having to be rebooted every time the system is moved from one room to another.

The presentation is implemented as a computer program accessed by the processor using either the CD-ROM/DVD drive or the network port; communicated visually by the touchscreen and audibly by the speaker or the headphone jack; and navigated or otherwise controlled through the touchscreen. As mentioned, the presentation presents information about a medical or otherwise health-related subject. Generally, the presentation broadly comprises a number of sections, including a background section; a condition section; a remedy section; and a lifestyle section. The background section includes information related to general physiological or other medical or health information, such as organs or physiological processes, related to the health-related subject. The condition section includes information related to one or more abnormal medical conditions. The remedy section includes information related to one or more remedies for the one or more abnormal medical conditions discussed in the condition section. The lifestyle section includes information related to healthy lifestyle choices and activities for avoiding or recovering from the one or more abnormal medical conditions. These sections are each represented by and embodied in one or more detailed topic pages. Thus, for example, the lifestyle section may be represented by topic pages relating to healthy diet choices and exercise activities.

A substantial advantage of the presentation of the present invention over prior art presentation mechanisms is its ability to present the information using any appropriate and effective combination of a variety of media elements, such as, for example, video movie elements; audio elements; still picture or photographic or other graphic elements; text elements; interactive hyperlink elements; and advertising elements. Each of the topic pages may incorporate one or more of any of these varied media elements.

Thus, it will be appreciated that the present invention provides a number of substantial advantages over the prior art, including, for example, freeing the physician or nurse from being the initial, primary, or only provider of at least a portion of the information. This is particularly advantageous where the physician or nurse would otherwise have to provide the information multiple times to the patient and family members. Thus, inefficient redundancy is advantageously avoided. Furthermore, whereas in the prior art the patient or their family might have to wait a substantial amount of time before the physician or nurse could provide the information, the present invention makes the information available to the patient and their family at any time, both initially and for later review. This ready availability of information can advantageously reduce anxiety and other mental stresses.

Additionally, whereas in the prior art the physician or nurse might be frequently unavoidably interrupted during the presentation, the present invention suffers no such disadvantage, and, even where the presentation is interrupted by the patient, the stopping point is easily found and the presentation continued therefrom. Alternatively, the patient or their family can easily and conveniently return to an earlier point or otherwise review the presentation following an interruption. Thus, an additional source of inefficient redundancy is advantageously avoided.

Additionally, whereas in the prior art the patient and their family were required to substantially absorb and understand the information during the presentation, with little or no opportunity for later independent review, the present invention allows for such review, and further allows the patient and their family to control the speed of the presentation. Thus, understanding is advantageously enhanced.

Additionally, whereas in the prior art the physician's or nurse's presentation is from memory and not standardized, the present invention allows for a presentation carefully designed with appropriate and relevant input from, for example, physicians and nurses, social workers, counselors, and attorneys. This advantageously avoids any failure to discuss important issues, including risks, required to fully-understand and appreciate the patient's condition and to provide informed consent.

Additionally, the present invention advantageously incorporates a variety of media elements to enhance the presentation and provide a more effective delivery of the information.

Additionally, the present invention is adapted specifically for use in a health-care setting with the needs of the patient and their family in mind, thereby allowing the present invention to be practically and effectively used in, for example, patient's rooms or suites and waiting rooms. Such adaptations include the easily cleaned housing, the lockable cover, and the adjustable boom.

These and other important aspects of the present invention are more fully described in the section entitled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is an isometric view of a preferred first embodiment of a system of the present invention;

FIG. 2 is a rear elevational view of the system of FIG. 1;

FIG. 3 is a rear isometric view of a preferred second embodiment of the system of the present invention;

FIG. 4 is a front isometric view of the system of FIG. 3;

FIG. 5 is a first screen display of a preferred embodiment of a presentation generated by a computer program of the present invention;

FIG. 6 is a second screen display of the presentation;

FIG. 7 is a third screen display of the presentation;

FIG. 8 is a fourth screen display of the presentation;

FIG. 9 is a fifth screen display of the presentation; and

FIG. 10 is a sixth screen display of the presentation.

### DETAILED DESCRIPTION OF A PREFERRED EMBODIMENT

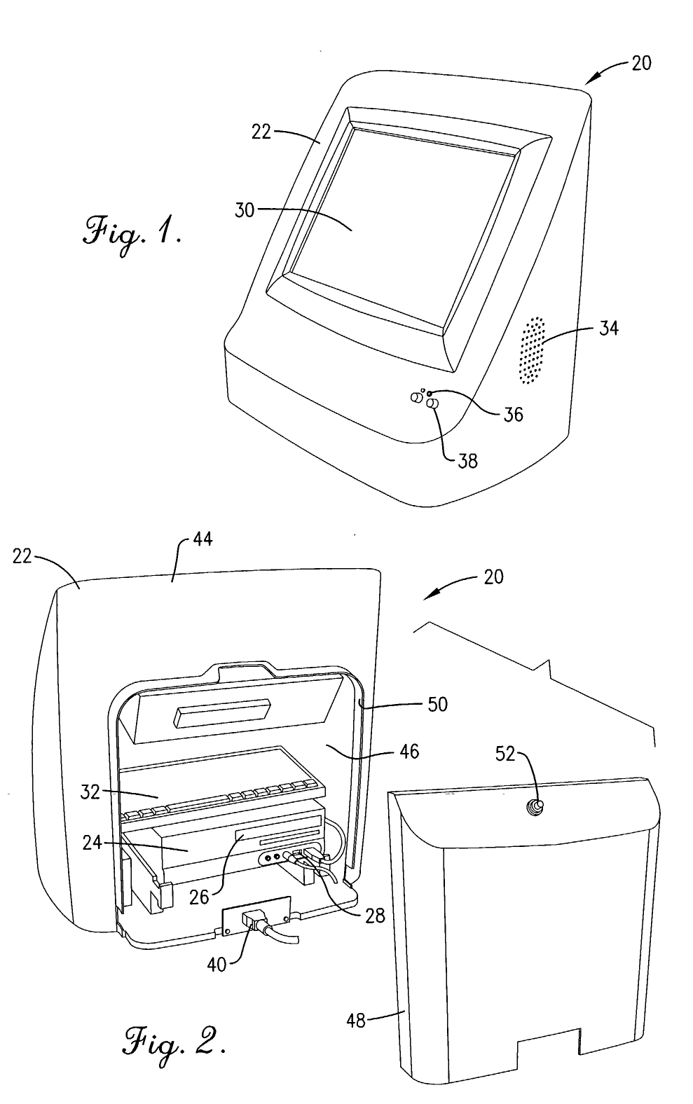

Referring to FIGS. 1 and 2, a system 20 is shown constructed in accordance with a preferred first embodiment of the present invention. The system 20 is adapted to provide a multi-media education and disclosure presentation on a medical or other health-related subject to a patient or other interested persons, such as, for example, family members or friends of the patient, or other user.

Though the presentation is described for illustrative purposes herein as concerning the particularly subject of heart health, it will be appreciated that the present invention is substantially independent of the subject of the presentation, so long as the subject is health-related. The presentation is discussed in greater detail below.

The preferred first embodiment of the system 20 is specifically adapted for fixed use in, for example, a foyer, waiting room, or similar environment for convenient access by the user. As such, the system 20 broadly comprises a housing 22; a processor 24; CD-ROM/DVD player 26 or a network port 28; a touchscreen 30 and a keyboard 32; a speaker 34 and a headphone jack 36; a volume control knob 38; and a power plug 40. The housing 22 protectively houses and encloses other components of the system 20, and is preferably constructed of a lightweight impact-resistant material, such as, for example, plastic, fiberglass, or carbon fiber, which may be reinforced as required. The housing 22 includes an exterior 44; an interior 46; and a cover 48.

It will be appreciated that the system 20 may experience substantial use in a health-care provider environment where contamination is a concern. Thus, the exterior 44 of the housing 22 is preferably shaped to present generally flat or gently rounded surfaces, thereby facilitating more efficient cleaning. Alternatively, the exterior 44 may be shaped, colored, or otherwise designed as desired. The interior 46 provides a cavity wherein other components of the system 20 are protectively located. The interior 46 is accessed through an opening 50 in a rear portion of the housing 22.

The cover 48 is adapted to be removably positioned and secured over the opening 50 so as to substantially seal the interior 46 and further protect the components located therein while allowing authorized access thereto. To ensure against unauthorized access, a locking mechanism 52, whether, for example, combination, key, or electronic in nature, is incorporated into the cover 48 and adapted to lockingly secure the cover 48 over the opening 50.

The processor 24 is substantially conventional and adapted to access and control and communicate the presentation, and to receive input from the user. The processor 24 may be, for example, a commonly available Pentium III 850 MHz processor or its equivalent.

The CD-ROM/DVD player 26 is substantially conventional and adapted to receive a memory device or medium on which the presentation is stored, to retrieve the information, and to provide the retrieved information to the processor 24 for presentation. It will be appreciated that the present invention is substantially independent of the nature of the memory device or medium on which the health-related information is stored, and, therefore, the CD-ROM/DVD player 26 may alternatively be any player/access unit suitable for use with the particular memory device or medium used.

Alternatively or additionally, the system 20 may include the network port 28 adapted to allow for connecting the processor 24 to a local or wide area network. Where such a connection is provided and used, the processor 24 may access the presentation from a remote host via the network rather than from the memory device or medium via the CD-ROM/DVD player 26.

The touchscreen 30 is substantially conventional and operatively coupled with the processor 24 and adapted to both visually communicate a visual component of the presentation and to allow the user to provide input for navigating and otherwise controlling the presentation. In a conventional manner, movement of an object, such as, for example, a finger, stylus, or other pointing device, on the touch-sensitive surface of the touchscreen 30 results in input to the processor 24. In this manner, the user can touch a virtual control that is part of the presentation and thereby provide a control input to the processor 24. Thus, the touchscreen 30 provides a self-contained and intuitive mechanism for controlling the presentation. The touchscreen 30 is readily available, for example, from suppliers such as Dell Computer Corp. The touchscreen 30 is incorporated into a frontal portion of the exterior 44 of the housing 22 so as to be conveniently visible to the user.

The keyboard 32 is substantially conventional and operatively coupled with the processor 24 and adapted to allow for providing input thereto. The keyboard 32 is provided for maintenance personnel rather than the user, and, as such, is preferably stored within the interior 46 of the housing 22 and accessed via the opening 50 when needed.

The speaker 34 is substantially conventional and operatively coupled with the processor 24 and adapted to audibly communicate an audible component of the presentation. The headphone jack 36 is similarly substantially conventional and adapted to provide an alternative to the speaker 24. Connection of a pair of headphones to the headphone jack 36 allows the user to listen to the presentation without disturbing others. Inclusion of the headphone jack 36 is particularly advantageous as, in hospitals and other health-care environments where noise is frequently undesirable, it allows for using the system 20 without disturbing others. The volume control knob 38 is actuatable by the user to control the volume of the presentation through the speaker 34 or the headphone jack 36.

The power plug 40 provides a connection point for connecting an external power source to the system 20 to provide power thereto.

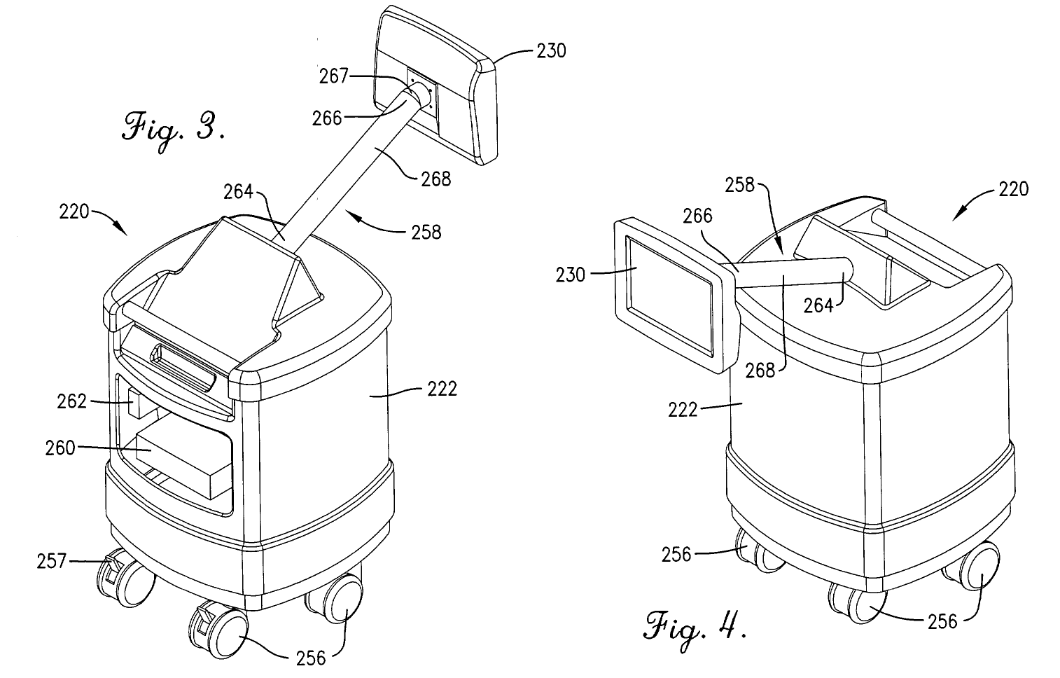

Referring also to FIGS. 3 and 4, a preferred second embodiment of the system 220 is shown which is substantially similar to the above-described first embodiment but for the following differences. The system 220 is specifically adapted for portable use by the user in the patient's room or suite or similar environment. As such, the system 220 broadly comprises the housing 222; the processor; the CD-ROM/DVD player or the network port; the touchscreen 230 and the keyboard; the speaker and the headphone jack; the volume control knob; and the power plug, as described above. To enhance the portable nature of the system 220, these components may be made smaller or lighter or be otherwise appropriately modified from those used on the first embodiment, particularly, for example, the touchscreen 230. Furthermore, the keyboard may be made available to the user, such as, for example, by securing it to a shelf or other suitable surface associated with the housing 222. The system 220 further comprises a plurality of wheels 256; an adjustable boom 258; a printer 260; and a battery 262.

The plurality of wheels 256 are mounted to a bottom portion of the housing 222 and are adapted to support the remainder of the system 220 and to allow for wheeled movement thereof, thereby further enhancing the portable nature of the system 220. There may be, for example, five wheels 256 arranged so as to provide maximum stability. The wheels 256 may be, for example, dual caster wheels, each having a 5 inch diameter and a 360° rotation. Furthermore, one or more of the wheels 256 may be provided with a locking latch or other braking mechanism 257 so that the system 220 can be securely positioned, for example, by the patient's bedside.

The adjustable boom 258 is an elongated substantially cylindrical support structure adapted to locate and support the touchscreen 230 in a desired position. The boom 258 includes a first end 264 having a first ball joint coupled with the housing 222; a second end 266 having a second ball joint 267 coupled with the touchscreen 230; and one or more telescopically, hingedly, or otherwise adjustable section 268 extending therebetween. Thus, the boom 258 is adjustable in three dimensions to facilitate positioning the touchscreen 230 for optimum viewing. This feature is particularly advantageous where the user is confined to a bed, in which case the wheeled housing 222 can remain next to the bed while the touchscreen 230 is positioned nearer the user.

The printer 260 is operatively coupled with the processor and allows for printing a consent form when the user has completed the presentation. As desired, the printer 260 can provide other verification and documentation (e.g., a usage report with date/time stamp) of the user's having used the system 220 and thereby received the presentation. As desired, the printer 260 can also be used to print hardcopies of the presentation for later review by the user.

The battery 262 supplements the power plug in providing power to the components of the system 220. Inclusion of the battery 262 further enhances the portable nature of the system 220 by allowing the system 220 to continue to receive power and remain on and avoid having to be rebooted every time the system 220 is moved from one room to another.

The presentation is implemented as a computer program accessed by the processor 24 using either the CD-ROM/DVD drive 26 or the network port 28; communicated visually by the touchscreen 30 and audibly by the speaker 34 or the headphone jack 36; and navigated or otherwise controlled through the touchscreen 30. The presentation may be created using any suitable software application, such as, for example, Microsoft Corporation's PowerPoint application, or programmed or otherwise written in any suitable programming language, such as, for example Java, C++, or HTML, and stored on the aforementioned suitable memory device or medium.

As mentioned, the presentation presents information about a medical or otherwise health-related subject. Generally, the presentation broadly comprises a number of sections, including a background section; a condition section; a remedy section; and a lifestyle section. It will be appreciated, however, that the inclusion and content of any particular section will depend heavily on the nature of the health-related subject. Thus, other appropriate sections not specifically disclosed herein may be devised and included.

The background section includes information related to general physiological or other medical or health information, such as organs or physiological processes, related to the health-related subject. Where the subject is heart health, for example, the background section may provide information about the heart organ and various heart and heart-affecting functions and processes.

The condition section includes information related to one or more abnormal medical conditions. In the heart health example, the condition section may include information about clogged arteries and heart attacks.

The remedy section includes information related to one or more remedies for the one or more abnormal medical conditions discussed in the condition section. In the heart health example, the remedy section may include information about stents used to treat clogged arteries or pacemakers used to prevent heart attacks.

The lifestyle section includes information related to healthy lifestyle choices and activities for avoiding or recovering from the one or more abnormal medical conditions discussed in the conditions section. In the heart health example, the lifestyle section may include information about healthy diet choices and exercise activities for avoiding clogged arteries and heart attacks.

As mentioned, one substantial advantage of the presentation of the present invention over prior art presentation mechanisms is its ability to present the information using any appropriate and effective combination of a variety of media elements, such as, for example, video movie elements; audio elements; still picture or photographic or other graphic elements; text elements; interactive hyperlink elements; and advertising elements. It will be appreciated that the inclusion and contents of any particular media element will depend heavily on the nature of the health-related subject. Similarly, other appropriate media elements not specifically disclosed herein may be devised and included. Each section may include any number and combination of these elements in its particular presentation and delivery of information.

The video movie elements may include, for example, live or prerecorded action, process animation, or video taken from or using a medical diagnostic instrument, such as, for example, an angiograph or endoscope. The audio elements may include, for example, a narration of the presentation's text elements or an audible accompaniment to the video movie elements. The still picture or photograph or other graphic elements may include, for example, one or more photographs, renderings, or illustrations. The text elements includes a textual discussion of information related to the subject or an aspect thereof, and may include, for example, tables, charts, or occurrence or risk statistics. The interactive hyperlinking elements allow for navigating the presentation and are particularly effective when combined with the touchscreen. The hyperlinking elements may take the form of highlighted of otherwise emphasized selectable text or selectable virtual buttons, switches, or dials. The hyperlinking elements may be interspersed throughout the presentation as needed, desired, or otherwise appropriate.

The advertising elements may include, for example, static, dynamic, logo, banner full-page, or hyperlinked advertisements, and may be interspersed throughout the presentation or limited to an advertisers/sponsors portion thereof. At least a portion of the advertisements are associated with the subject of the presentation. Thus, in the heart health example, topics may include surgical remedies, in which case the advertising elements may include advertisements for physicians or institutions specializing in performing the surgical remedies, or advertisements for particular brands of stents or pacemakers or other equipment used in the surgical procedures. The present invention's ability to incorporate advertising is a particularly advantageous feature because, whereas space and technology limitations heretofore limited the use of advertising in prior art presentations (e.g., oral discourses, pamphlets, video cassettes), the increased capacity and multi-media capabilities of the present invention allow for advertising as a means for additional revenue. Such additional revenue, it will be appreciated, may in turn be used to offset the cost of manufacturing and purchasing the system 20.

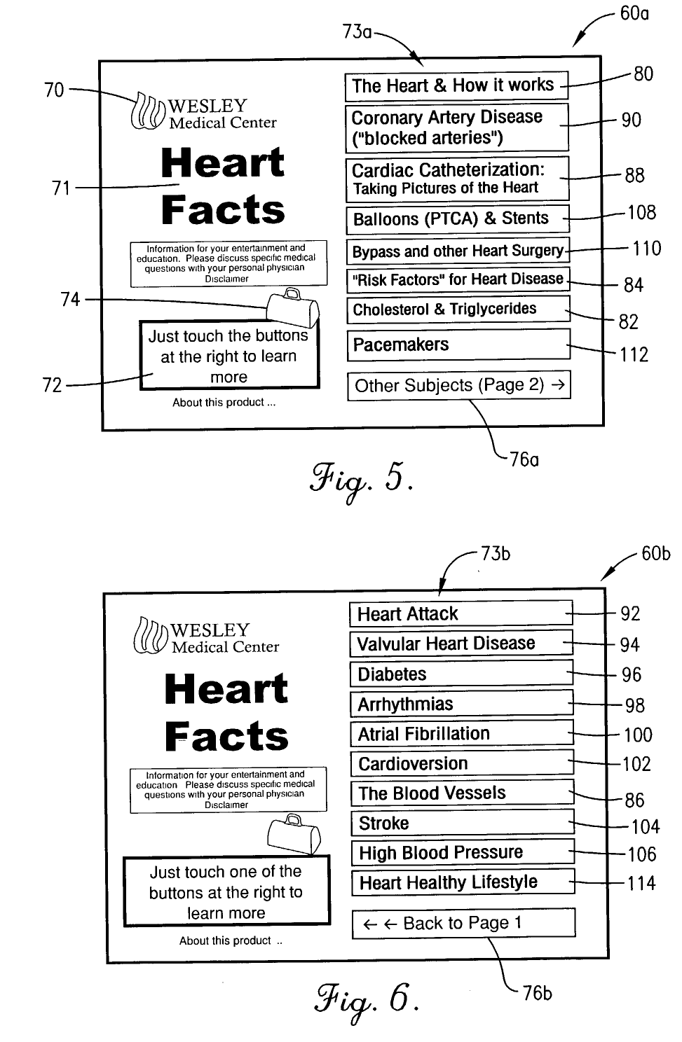

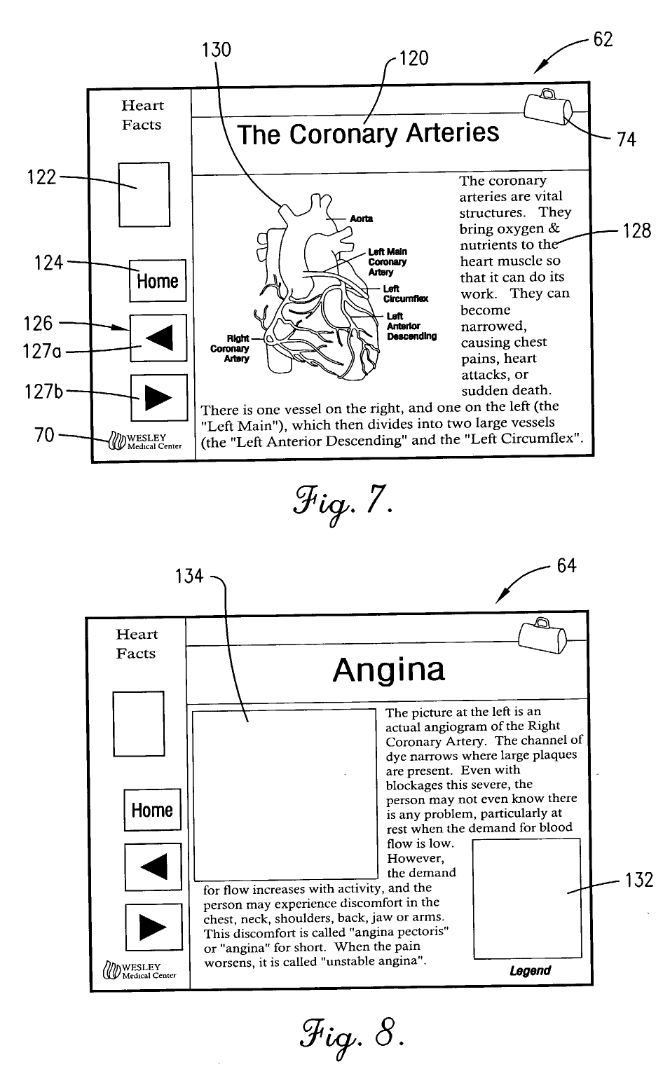

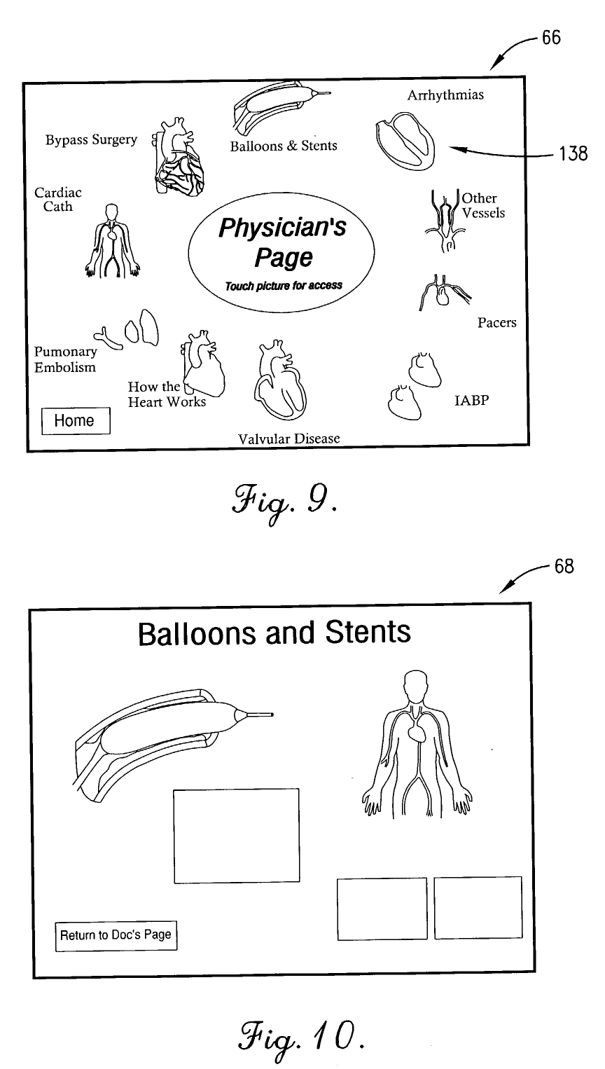

FIGS. 5-10 illustrate a portion of an exemplary presentation of information related to heart health. The presentation takes the form of a number of “pages” which correspond to topics, including first and second Main or Home pages 60a,60b (FIGS. 5 and 6); a Coronary Arteries page 62 (FIG. 7); an Angina page 64 (FIG. 8); a Physician's Page page 66 (FIG. 9); a Balloons and Stents page 68 (FIG. 10); and a Confirmation page (not shown).

The Home pages 60a,60b include an institutional logo 70; a title 71 of the presentation; navigation and control instructions 72; a first part of a menu 73a; a Doc's Bag icon 74; and a Page 2 hyperlink 76a. The logo 70 is optionally included as a mechanism for customizing the presentation to the institution to which the system 20 belongs. Alternatively, the logo 70 may indicate the manufacturer or other provider of the system 20. The navigation and control instructions 72 indicate how the user is to navigate through and otherwise use the presentation. These instructions 72 may, for example, be as simple as “Just touch one of the buttons at the right to learn more”. The first part of the menu 73a provides a plurality of selectable hyperlinks in the form of virtual buttons. These hyperlinks correspond to topics and provide access to topic pages of the presentation. Touching the touchscreen 30 over one of these hyperlinks causes the selected page to appear. The Doc's Bag icon is a hyperlink icon whose selection causes to appear the Physician's Page page 66. The Page 2 hyperlink 76a is a hyperlink whose selection causes to appear the second Home page 60b.

The second Home page 60b is substantially similar in functionality and appearance to the first Home page 60a except that a second part of the menu 73b is provided, and a Page 1 hyperlink 76b leads back to the first Home page 60a.

With regard to the first and second part of the menu 73a,73b, the selectable hyperlinks provide descriptive titles corresponding to the topics of the pages to which the hyperlinks lead, thereby making user navigation easier and more convenient. The background section of this particular presentation includes pages corresponding to and accessed by selecting a “The Heart and How it Works” link 80, a “Cholesterol and Triglycerides” link 82, a “Risk Factors for Heart Disease” link 84, a “The Blood Vessels” link 86, and a “Cardiac Catheterization” link 88. The condition section includes pages corresponding to and accessed by selecting a “Coronary Artery Disease” link 90, a “Heart Attack” link 92, a “Valvular Heart Disease” link 94, a “Diabetes” link 96, an “Arrhythmias” link 98, an “Atrial Fibrillation” link 100, a “Cardioversion” link 102, a “Stroke” link 104, and a “High Blood Pressure” link 106. The remedies section includes pages corresponding to and accessed by selecting a “Balloons (PYTCA) and Stents” link 108, a “Bypass and Other Heart Surgery” link 110, and a “Pacemakers” link 112. The lifestyle section includes pages corresponding to and accessed by selecting a “Heart Healthy Lifestyle” link 114. The topics and information presented on the pages corresponds directly to their titles.

The Coronary Arteries page 62, for example, is accessed by selecting “The Heart and How it Works” link 80 from the first part of the menu 73a provided on the first Home page 60a. The Coronary Arteries page 62 is typical of most of the pages of the presentation in that it includes a topic title 120; the Doc's Bag icon 74; the institution logo 70; an advertising component 122; a Home link 124; and one or more navigation controls 126. The Home link 124 is a hyperlink whose selection returns the user to the first Home page 60a. The one or more navigation controls 126 appear as selectable virtual arrow buttons. The arrow buttons 126 make navigating the presentation substantially intuitive, with, for example, a right pointing arrow 127a corresponding to advancing the presentation to a new page, and a left pointing arrow 127b corresponding to returning the presentation to a previous page. Furthermore, the arrow buttons 126 are preferably oversized to accommodate users with impaired motor skills or eyesight. Note that the Coronary Arteries page 62 is shown incorporating both text 128 and a still or animated image 130 in its presentation.

The Angina page 64 is accessed by selecting the “Coronary Artery Disease” link 90, but is otherwise substantial similar to the Coronary Arteries page 62. Note that the Angina page 64 is shown incorporating both a still image 132 and a pre-recorded video clip 134 of an angiogram taken using an angiograph.

The Physician's Page page 66 is accessed, as mentioned, via the Doc's Bag icon 74 and provides a plurality of selectable hyperlinked graphics 138. Selection of any one of the graphics 138 causes to appear a physician's page that corresponds to one of the aforementioned topic pages but which includes only the non-text media elements, such as, for example, video, audio, and images, from those topic pages. The physician's pages are provided as an aid to the physician or nurse as they explain concepts to the user. Having no explanatory text, neither the Physician's Page page 66 nor any of the physician's pages reached therefrom are intended for viewing by the user without the physician or nurse present.

For example, the Balloons and Stents physician's page 68 is one of the pages reached by selecting a corresponding hyperlinked graphic on the Physician's Page page 66, and which corresponds to the topic page reached by selecting the “Balloons (PCTA) and Stents” link 108 on the first Home page 60a. As mentioned, the Balloon's and Stents physician's page 68 provides only the non-text media elements available on the Balloon's and Stent topic page.

The Confirmation page is not selectable for presentation, but rather appears automatically when the presentation is complete. The Confirmation page prompts the user to indicate whether they have understood the information presented. This may be achieved, for example, by providing YES and NO selectable virtual buttons. If YES is selected, the printer 260 may print an appropriate consent form for signature by the user. If NO is selected, the physician or nurse may be notified to assist the userto understand the presentation or specific portions thereof. In the latter case, the non-text media elements accessed via the Physician's Page page 66 may be used by the physician or nurse as an aid in explaining the information.

In exemplary use and operation, the system 220 is used to educate and disclose relevant information to the user. The system 220 is wheeled from another room to the user's bedside. The boom 258 is adjusted horizontally and vertically until the touchscreen 230 achieves a position which is comfortable for the user to both see and touch. The first Home page 60a is the primary page to which the presentation defaults, particularly upon initial startup, and is the page the user will initially encounter.

Reading the navigation and control instructions 72, the user's intuitive understanding of how to navigate the presentation is confirmed. Wanting to view the complete menu of topics 73a,73b before beginning, the user selects the Page 2 hyperlink 76a by touching the touchscreen 230 over the Page 2 hyperlink 76a to cause the second Home page 60b to appear. The user then selects the Page 1 hyperlink 76b to return to the first Home page 60a, and then selects the “Heart and How it Works” link 80 to cause to appear the corresponding topic page. Thereafter the user proceeds through the various topic pages, learning about the health-related subject.

At the end of the presentation, the Confirmation page appears prompting the user to answer YES or NO by selecting an appropriate virtual button. The user, not having understood the pacemaker information (accessed by selecting the “Pacemakers” link 112), answers NO. Later, the physician sees that the user answered no, and is able to select the Doc's Bag icon 74 to cause to appear the Physician's Page 66 from which the physician selects an appropriate hyperlink graphic to cause to appear the non-text media elements found on the pacemaker topic page. The physician is then able to refer to these media elements while answering the user's questions.

Following this supplemental explanation, the user is able to answer YES to the question presented by the Confirmation page. This results in an appropriate consent form and other documentation being printed which can be signed by the user and entered into the user's file as evidence of the information presented to the user.

From the preceding discussion, it will be appreciated that the present invention provides a number of substantial advantages over the prior art, including, for example, freeing the physician or nurse from being the initial, primary, or only provider of at least a portion of the information. This is particularly advantageous where the physician or nurse would otherwise have to provide the information multiple times to the patient and their family members. Thus, inefficient redundancy is advantageously avoided. Furthermore, whereas in the prior art the patient or their family might have to wait a substantial amount of time before the physician or nurse could provide the information, the present invention makes the information available to the patient and their family at any time, both initially and for later review. This ready availability of information can advantageously reduce anxiety and other mental stresses.

Additionally, whereas in the prior art the physician or nurse might be frequently unavoidably interrupted during the presentation, the present invention suffers no such disadvantage, and, even where the presentation is interrupted by the patient, the stopping point is easily found and the presentation continued therefrom. Alternatively, the patient or their family can easily and conveniently return to an earlier point or otherwise review the presentation following an interruption. Thus, an additional source of inefficient redundancy is advantageously avoided.

Additionally, whereas in the prior art the patient and their family were required to substantially absorb and understand the information during the presentation, with little or no opportunity for later independent review, the present invention allows for such review, and further allows the patient and their family to control the speed of the presentation. Thus, understanding is advantageously enhanced.

Additionally, whereas in the prior art the physician's or nurse's presentation is from memory and not standardized, the present invention allows for a presentation carefully designed with appropriate and relevant input from, for example, physicians and nurses, social workers, counselors, and attorneys. This advantageously avoids any failure to discuss important issues, including risks, required to fully-understand and appreciate the patient's condition and to provide informed consent.

Additionally, the present invention advantageously incorporates a variety of media elements to enhance the presentation and provide a more effective delivery of the information.

Additionally, the present invention is adapted specifically for use in a health-care setting with the needs of the patient and their family in mind, thereby allowing the present invention to be practically and effectively used in, for example, patient's rooms or suites and waiting rooms. Such adaptations include the easily cleaned housing 22, the lockable cover 48, and the adjustable boom 258.

Although the invention has been described with reference to the preferred embodiment illustrated in the attached drawings, it is noted that equivalents may be employed and substitutions made without departing from the scope of the invention as recited in the claims. Thus, for example, features described in association with a particular system embodiment are not necessarily limited to that embodiment and may, therefore, be combined with or incorporated into another embodiment as desired.

Having thus described the preferred embodiment of the invention, what is claimed as new and desired to be protected by Letters Patent includes the following:

1. A system comprising:
a housing;
a computer program adapted to provide a multi-media presentation of healthrelated information;
a processor located within the housing and adapted to access the healthrelated information; and
a touchscreen input mechanism operatively connected to the processor and adapted to communicate a visual component of the multi-media presentation, and further adapted to allow a user to input a selection to the processor.

2. The system as set forth in claim 1, wherein the housing includes an opening and a cover adapted to selectively cover the opening, with the cover including a locking mechanism adapted to selectively substantially prevent access to an interior of the housing via the opening.

3. The system as set forth in claim 2, further including an alphanumeric keyboard stored within the housing and accessible via the opening.

4. The system as set forth in claim 1, wherein the computer program includes
a code segment adapted to provide a background section of the health-related information, wherein the background section includes general physiological information;
a code segment adapted to provide a condition section of the health-related information, wherein the condition section includes information regarding a detrimental health effect;
a code segment adapted to provide a remedy section of the health-related information, wherein the remedy section includes information regarding a remedy for the detrimental health effect; and
a code segment adapted to provide a lifestyle section of the health-related information, wherein the lifestyle section includes information regarding a healthy lifestyle.

5. The system as set forth in claim 1, wherein the multi-media presentation includes a video element, an audio element, a still image element, and a text element for communicating the health-related information.

6. The system as set forth in claim 5, wherein the video element includes a pre-recorded video movie of a medical procedure.

7. The system as set forth in claim 5, wherein the video element includes a pre-recorded video movie of a view provided by a medical diagnostic device.

8. The system as set forth in claim 5, wherein the video element includes animation.

9. The system as set forth in claim 1, further including
a speaker operatively connected to the processor and adapted to communicate an audible component of the multi-media presentation;
a headphone jack operatively coupled with the processor and adapted to cooperate with a headphone to communicate the audible component; and
a volume control adapted to allow the user to adjust the volume of communication of the audible component.

10. The system as set forth in claim 1, further including a plurality of wheels coupled with and adapted to support the housing; and
a rechargeable battery adapted to power the processor and the touchscreen, thereby making the system substantially portable.

11. The system as set forth in claim 1, further including an adjustable boom having a first end and a second end, with the first end being coupled with the housing and the second end being coupled with the touchscreen, and the adjustable boom being adapted to allow for positioning the touchscreen relative to the housing.

12. The system as set forth in claim 1, further including a network connection operatively coupled with the processor and adapted to facilitate access to a computer network.

13. The system as set forth in claim 1, further including a printer operatively coupled with the processor and adapted to provide a hardcopy printout of material.

14. The system as set forth in claim 13, wherein the material includes a consent form.

15. A system adapted to provide a multi-media presentation of health-related information comprising:
a housing including an opening and a cover adapted to selectively cover the opening, with the cover including a locking mechanism adapted to selectively substantially prevent access to an interior of the housing via the opening;
a plurality of wheels coupled with and adapted to support the housing and to facilitate movement thereof;
a computer program adapted to generate the multi-media presentation, wherein the multi-media presentation includes a video element, an audio element, a still image element, and a text element for communicating the health-related information, the computer program including
a code segment adapted to provide a background section of the health-related information, wherein the background section includes general physiological information,
a code segment adapted to provide a condition section of the health-related information, wherein the condition section includes information regarding a detrimental health effect,
a code segment adapted to provide a remedy section of the health-related information, wherein the remedy section includes information regarding a remedy for the detrimental health effect, and
a code segment adapted to provide a lifestyle section of the health-related information, wherein the lifestyle section includes information regarding a healthy lifestyle;
a processor located within the housing and adapted to access the health-related information;
a touchscreen input mechanism operatively connected to the processor and adapted to communicate a visual component of the multi-media presentation, and further adapted to allow a user to input a selection to the processor; and
an adjustable boom having a first end and a second end, with the first end being coupled with the housing and the second end being coupled with the touchscreen, and the adjustable boom being adapted to allow for positioning the touchscreen relative to the housing.

16. The system as set forth in claim 15, further including an alphanumeric keyboard stored within the housing and accessible via the opening.

17. The system as set forth in claim 15, wherein the video element includes a pre-recorded video movie of a medical procedure.

18. The system as set forth in claim 15, wherein the video element includes a pre-recorded video movie of a view provided by a medical diagnostic device.

19. The system as set forth in claim 15, wherein the video element includes animation.

20. The system as set forth in claim 15, further including a speaker operatively connected to the processor and adapted to communicate an audible component of the multi-media presentation;
a headphone jack operatively coupled with the processor and adapted to cooperate with a headphone to communicate the audible component; and
a volume control adapted to allow the user to adjust the volume of communication of the audible component.

21. The system as set forth in claim 15, further including a rechargeable battery adapted to power the processor and the touchscreen, thereby making the system substantially portable.

22. The system as set forth in claim 15, further including a network connection operatively coupled with the processor and adapted to facilitate access a computer network.

23. The system as set forth in claim 15, further including a printer operatively coupled with the processor and adapted to provide a hardcopy printout of material.

24. The system as set forth in claim 23, wherein the material includes a consent form.

25. A method of providing a multi-media presentation of health-related information, the method comprising the steps of:
(a) providing a system adapted to communicate the multi-media presentation;
(b) providing an adjustment mechanism whereby a user can adjust a physical positioning of at least a portion of the system for more convenient viewing of the multi-media presentation;
(c) providing an input mechanism with which the user of the system can provide an input for controlling the multi-media presentation;
(d) prompting the user, when the multi-media presentation is complete, to indicate whether the multi-media presentation was understood; and
(e) printing a form in response to a positive indication in step (d).

26. The method as set forth in claim 25, further including the step of (f) providing, as part of the multi-media presentation, a plurality of sections including a background section of the health-related information including general physiological information;
a condition section of the health-related information including information regarding a detrimental health effect;
a remedy section of the health-related information including information regarding a remedy for the detrimental health effect; and
a lifestyle section of the health-related information including information regarding a healthy lifestyle.

27. The method as set forth in claim 25, further including the step of (f) incorporating into the multi-media presentation a plurality of multi-media elements including a video element, an audio element, a still image element, and a text element for communicating the health-related information.

28. A method of providing a multi-media presentation of health-related information, the method comprising the steps of:
(a) providing, as part of the multi-media presentation, a plurality of sections including
a background section of the health-related information including general physiological information,
a condition section of the health-related information including information regarding a detrimental health effect,
a remedy section of the health-related information including information regarding a remedy for the detrimental health effect, and
a lifestyle section of the health-related information including information regarding a healthy lifestyle;
(b) incorporating into the multi-media presentation a plurality of multimedia elements including a video element, an audio element, a still image element, and a text element for communicating the health-related information.
(c) providing a system adapted to communicate the multi-media presentation;
(d) providing an adjustment mechanism whereby a user can adjust a physical positioning of at least a portion of the system for more convenient viewing of the multi-media presentation;
(e) providing an input mechanism with which the user of the system can provide an input for controlling the multi-media presentation;
(f) prompting the user, when the multi-media presentation is complete, to indicate whether the multi-media presentation was understood; and
(g) printing a form in response to a positive indication in step (d).

29. A computer program adapted to provide a multi-media presentation of health-related information, the computer program comprising:
a code segment adapted to provide a background section of the health-related information, wherein the background section includes general physiological information;
a code segment adapted to provide a condition section of the health-related information, wherein the condition section includes information regarding a detrimental health effect;
a code segment adapted to provide a remedy section of the health-related information, wherein the remedy section includes information regarding a remedy for the detrimental health effect;
a code segment adapted to provide a lifestyle section of the health-related information, wherein the lifestyle section includes information regarding a healthy lifestyle; and
a code segment adapted to provide a one or more virtual controls, including a virtual navigation control, adapted to allow for controlling the multimedia presentation.

30. The computer program as set forth in claim 29, wherein the virtual navigation control is a large-sized electronically selectable virtual direction arrow.

31. The computer program as set forth in claim 29, wherein the multimedia presentation includes a video element, an audio element, a still image element, and a text element.

32. The computer program as set forth in claim 29, wherein the video element includes a pre-recorded video movie of a medical procedure.

33. The computer program as set forth in claim 29, wherein the video element includes a pre-recorded video movie of a view provided by a medical diagnostic device.

34. The computer program as set forth in claim 29, wherein the video element includes animation.
